(19) United States
(12) Patent Application Publication
(10) Pub. No.: US 2006/0275635 A1
(43) Pub. Date: Dec. 7, 2006

(54) Todd J. Tocco self replenishing condensation to hydrogen fuel cell or hydrogen from any type of refrigerant system fuel cell or any type of refrigerant system to hydrogen fuel cell any type of refrigerant that can produce a frost like surface or water on any surface can produce hydrogen gases out of thin air with aide of saline solution in a rechargeable aerosol spray tank

(76) Inventor: Todd J. Tocco, Schenectady, NY (US)

Correspondence Address: Todd J. Tocco, 2014 Fiero Avenue, Schenectady, NY, 12303-4109, US

(21) Appl. No.: 11/378,656

(22) Filed: Mar. 17, 2006

Related U.S. Application Data
(60) Provisional application No. 60/686,298, filed on Jun. 2, 2005.

(51) Int. Cl. H01M 4/00; H01M 2/38

(52) U.S. Cl. 429/27; 429/67

(57) ABSTRACT

I claim this is a self replenishing condensation fuel cell which means it makes all its own hydrogen gases right out of thin air with the aide of any type of refrigerant system that can produce a frost like surface on any surface or what is commonly known as condensation. The vehicles exhaust thaws out the refrigerant tubing the water falls to the carbon coated reservoir where the 50 negatively charged carbon discs and pipe are the positively charged rod is inside of the pipe. A concentrated sodium chloride or a saline solution in a rechargeable pressurized aerosol spray air tank which has a PH indicator that automatically measures for the proper sodium chloride levels in the condensation water before the electro-dialysis or reverse osmosis process can begin which makes all the hydrogen and oxygen gases the hydrogen is stored in the fuel cell itself, while the oxygen is expelled.

I Todd J. Tocco being the sole inventor: Of this self replenishing condensation fuel cell and I use a concentrated sodium chloride (NaCl) formula in a pressurized stainless steel S32750 grade air tank to be used as an aerosol spray to administer the sodium chloride (NaCl) in the proper PH levels to aide in the separation of the hydrogen and oxygen gases the hydrogen will be used to power our vehicles and other energy devices in this self replenishing fuel cell. I claim: Condensation from any type of refrigeration system that can produce a cold frost like surface can produce hydrogen gases and. I claim: This is based on how an air-conditioner works it will work on all types of automobiles including trucks and even generators to and even home energy systems can use this fuel cell. I claim: Any type of hydrogen engine with and exhaust system that can later be used as a heating element.

Hydrogen is the most common of all our planets resources, we drink it an breath it an it's even in our plants. A refrigerant is used in our air-conditioner systems, this extremely cold gas is idea for this application because of the side effect which is, it creates water, by way of condensation. This system we call and air-conditioner is being used as part of our daily routine it forces air out that is being vacuumed across the refrigerant tubing to create the colder air. This cold air is used in countless of other resources like, to keep our foods cold and to keep us cooler on those hot summer days and nights. But the side effect is what this system is in need of, where it produces water by way of condensation. I claim: Have you ever seen water dripping out the back of and air-conditioner now that's what I'm taking about. This is caused by the warm air being vacuumed across the refrigerant tubing, its this side effect like in an air-conditioner is what hydrogen powered vehicle's are in need of that is a source of water for the electro-dialysis or the reverse osmosis process and with the aide of the pressurized concentrated sodium chloride (NaCl) in a rechargeable stainless steel air tank to be used as an aerosol spray canister. This process will create all the hydrogen gases that is needed to power all these products. By electrifying the water through the electro-dialysis or the reverse osmosis process that it produces these two elements hydrogen and oxygen gases. From what is commonly known as H2O. This fuel cell will produce it's own hydrogen fuel by injecting or spraying the concentrated sodium chloride into the condensation water from the pressurized stainless steel air tank thus producing through electro-dialysis or reverse osmosis of the water the gases that are needed to power the worlds hydrogen engines. That's right, this system will make it's own fuel, so and end to gas stations once and for all. Well maybe not an end you'll still need to get your vehicles tuned up and to have your concentrated pressurized sodium chloride (NaCl) aerosol spray air tank recharged about once every 3 months with your oil change but in this case synthetic oil. You see you don't need a lot of sodium chloride for this fuel cell to work properly and because the sodium is under pressure and a PH indicator gauge in the condensation water reservoir and another on the vehicles dashboard in the display a sodium aerosol pressure gauge coming from the aerosol tank which is connected to the sprayer just above the water reservoir. As the water levels rises a sensor in the water reservoir automatically, premixes the right amount of sodium chloride PH levels for the condensation water to be the right PH levels before the electro-dialysis or reverse osmosis process can start. So for the motorist no more waiting in long lines or in bad whether this system will have the capability to create hydrogen gases right out of thin air. When its warm outside our air-conditioners systems produce a lot of water a shut off heat value sensor on the exhaust system that is going to the refrigerant chamber is automatically turned off as needed when tempters require it this is a butterfly on and off value. Using a somewhat smaller fuel tank say a two hundred mile capacity is ideal over anything larger taking up to much room and adding to much weight to the vehicle. With both the pressurized tanks one for the hydrogen fuel to be used as a storage fuel tank and a much smaller sodium air tank for the pressurized sodium chloride (NaCl) concentrate. Because the fuel cell is a self replenishing system there is know need for a big storage fuel tank as this system has the capability to work after the engine has been shut off for the night. That is when the backup system is turned on and the electric heating element in the back of the fuel cell is activated which blows hot air across the refrigerant tubing to make even more water from the condensation and because it doesn't use a lot of electricity in the electrolysis or reveres osmosis process to create even more hydrogen gases which are vacuumed off to the fuel storage holding tank. A hydrogen engine exhaust system won't be quite the same, there will be some retrofitting to adopt it to the fuel cell. A 2″ pipe cross over from the manifold pipes in the exhaust system coming up and forwards, from the pistons in the engine compartment go to the refrigerant chamber I'm using this as my heating sources because its and easy and clean and cheap way to heat up the refrigerant tubing and there are no real dangers to anyone or anything by using this as a heating source, to act like the vacuuming system in an air-conditioner by blowing the hot air across the refrigerant tubing instead of being sucked across it. And the only real side effect is a little carbon or soot-like substance, that maybe left in the system. But I use the engine to its maximum capacity this brings forced heat forwards to what I call the refrigerant chamber, something like a big hollow 16 cm wide tub and 61 cm long in it there is three layers of spiraling refrigerant tubing spiraling across the length of the tubing in the center of the three layers is A 2″ or 5 cm exhaust pipe connecting to the vehicles manifold in the engine compartment as the hot air blows through this pipe it hits these holes in the pipe these holes are on each side's of the spiraling refrigerant tubing as the jets of hot air passes by and warms the tubing and the mass of the air flow leaves the refrigerant chamber on the far other side of the interior wall of the refrigerant chamber it then blows the hot air back out to the vehicles exhaust pipe opening on the opposite side. As it then produces water from the thawing out of the tubing as the water forms it makes it way through the opening at the bottom of the refrigerant chamber, and pours down to the reservoir. It's now in place for the electro-dialysis or reverse osmosis process. This tank is a stainless steel condensation water tank or reservoir. I claim: At the very bottom of the reservoir it is all carbon coated or carbon plated inside and below the condensation water line its almost ready for the electro-dialysis or reverse osmosis process. Its at this point the PH indicator adjusts the sodium levels by injecting the pressurized sodium chloride concentrated spray into the condensation water and placed inside of the condensation water reservoir are the two separate cathode electrode unit's.

I claim: There are a series of carbon plates like a 50 to 1 ratio with 50 parts carbon plated discs these are all negatively charged terminals as the hydrogen producing plates, and the 1 present oxygen producing rod 1 part positive and the carbon plates are mounted on a hollow carbon plated tubing or pipe each plate is about 16 cm wide or across, with a 5 cm hole in the center this hole is for the carbon plated pipe or tub to pass or go directly through the center of each plate or disc each plate is spaced out about ½-cm apart and the carbon rod is about 1.5 cm wide or thick by 61 cm long. This carbon plated rod goes through the center of the carbon plated tubing and this is located at the very bottom of the carbon plated reservoir at each end of the positive carbon plated rod, is a glass spacer which allows water in and air out at both ends of this tubing inside of the tubing the positive electro rod goes through it and is fitted at the bottom as not to touch the bottom of the inside of the pipe or tubing it lets the condensation water go all the way through it. And the oxygen gases once created move out of it freely the oxygen is a waste product and is expelled back out into the refrigerant chamber's water reservoir. Placed over and around the discs is the carbon coated stainless steel S32750 gas cantonment system which mounts to the interior shell on three sides at the top and at both sides leaving the bottom just under the water line open this is the water and hydrogen gas cantonment system. Which traps the hydrogen gases but allows the water free passage. As the electrifying starts the process an the tiny gas bubbles start to form around each of the carbon plates, and the carbon rod the oxygen moves or goes out through each of the ends of tubing back into the refrigerant chamber water supply or reservoir and the hydrogen gas is trapped in the water and reverse-osmosis cantonment system and later vacuumed pumped off into the storage fuel holding tank The 50 discs produces all the hydrogen with a small a mount of oxygen like 1 percent being produced as oxygen. As the hydrogen gas rises out of the water it is being vacuumed pumped off to the fuel holding tank to later be used to power the vehicle and the oxygen is expelled out back into the refrigerant chamber and the over-flow of water goes out of a over-flow port just above the disc cantonment chamber. And now if this system was say a submarine the oxygen could be used and not expelled. To avoid the fuel cell from freezing up in the dead of winter antifreeze is used and placed into what I call and a double boiler this is out side of the reservoir and around it to keep the water from freezing in the reservoir if the hot air coming down from the refrigerant chamber isn't enough to keep it thawed out the double boiler has enough heat as it is coming from the engines coolant system on the return trip from the radiator by this time it has cooled off enough as not to boil the pre-mixed sodium chloride concentrate condensation water it then makes it way through the hollow like block this has two ports one for and inlet and one for and outlet on the side and is placed directly underneath or around the water reservoir which is where the electro-dialysis or reverse osmosis process tank is this will help to thaw out any frozen water that may be left in the system and as the antifreeze is pumped through it then returns to the engine to restart the process.

As set forth in the following specification:

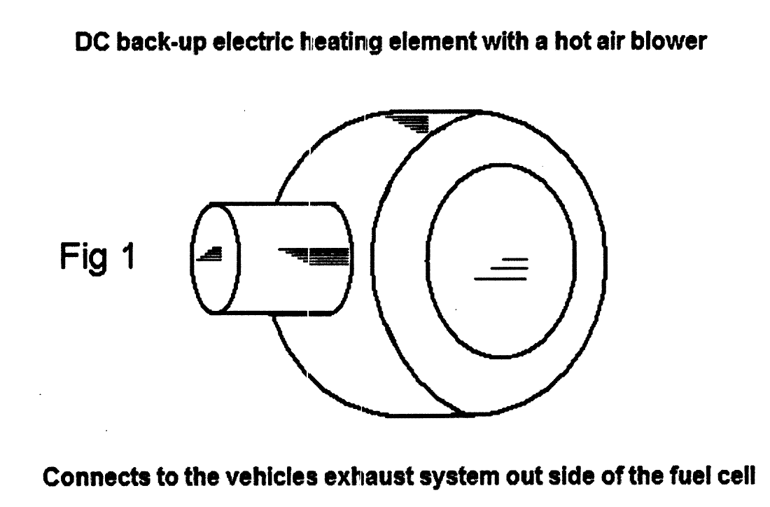

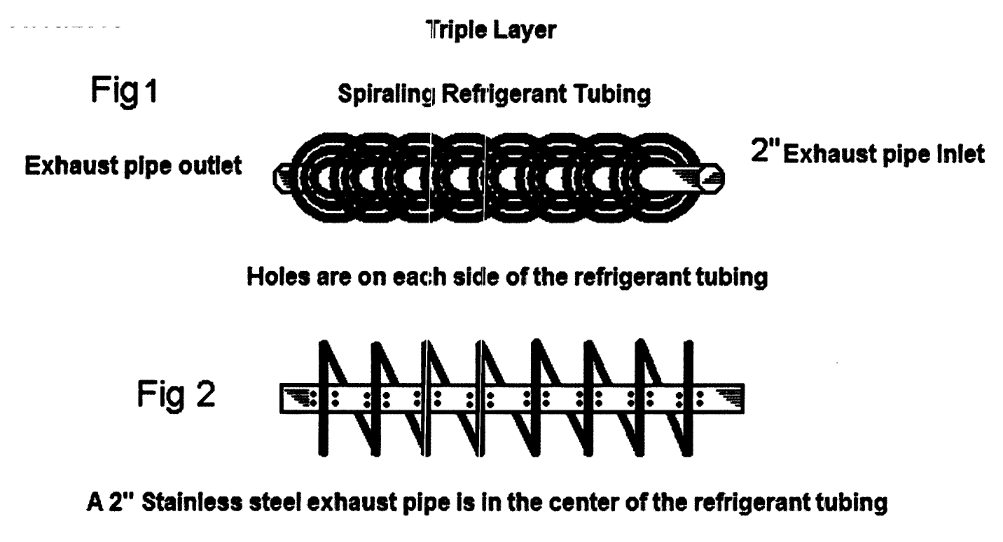

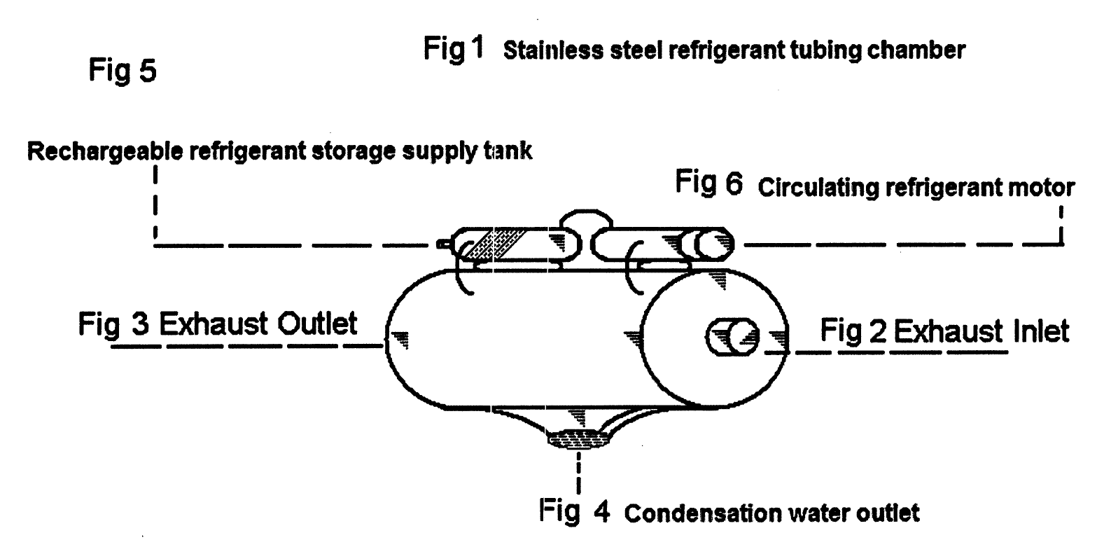

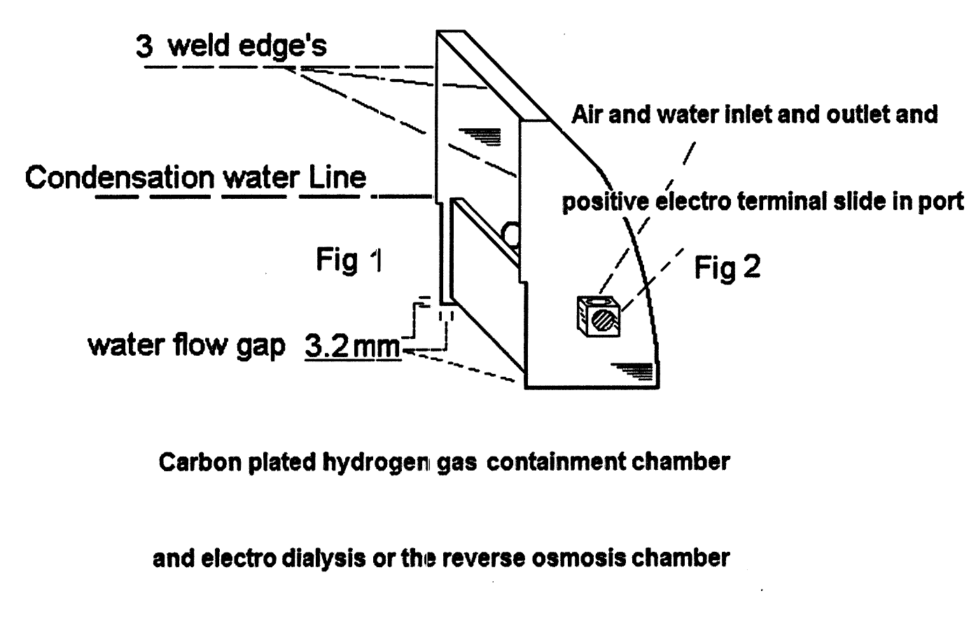

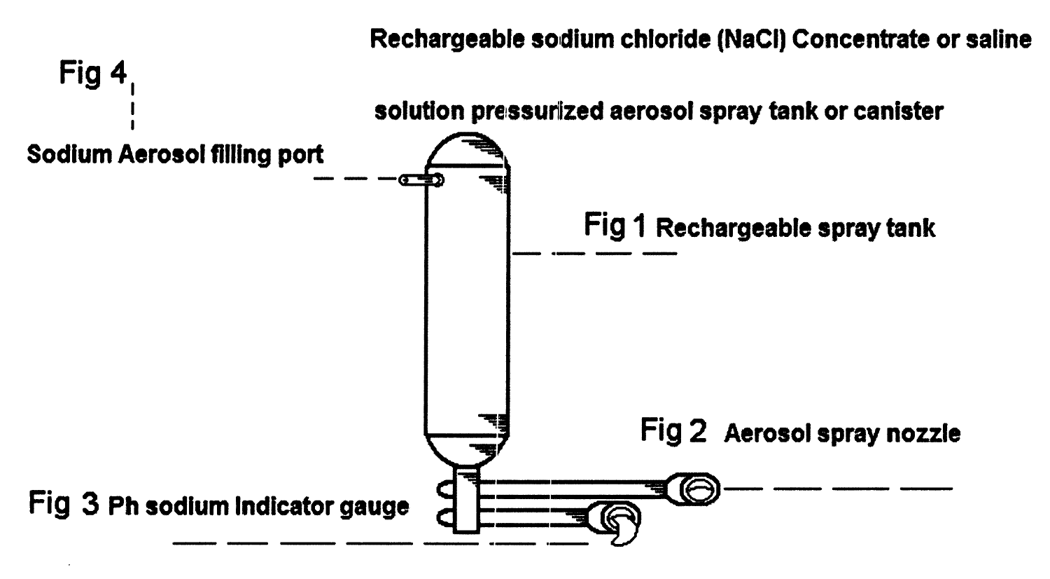

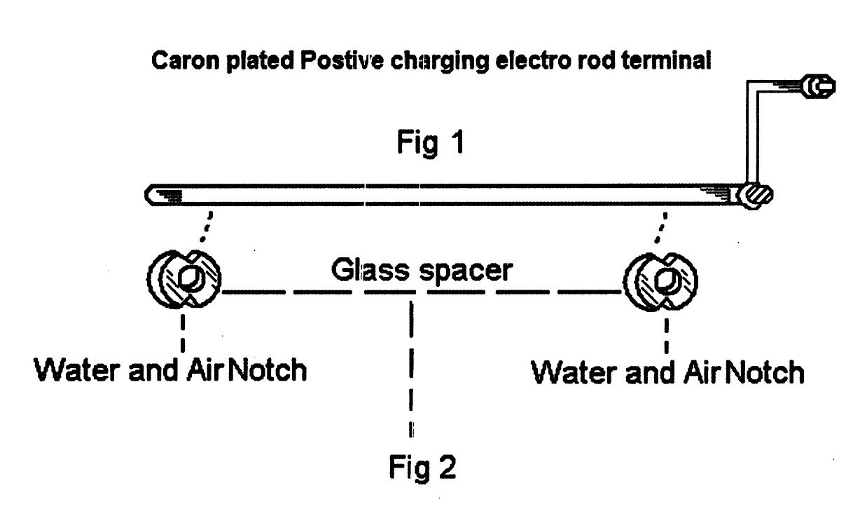

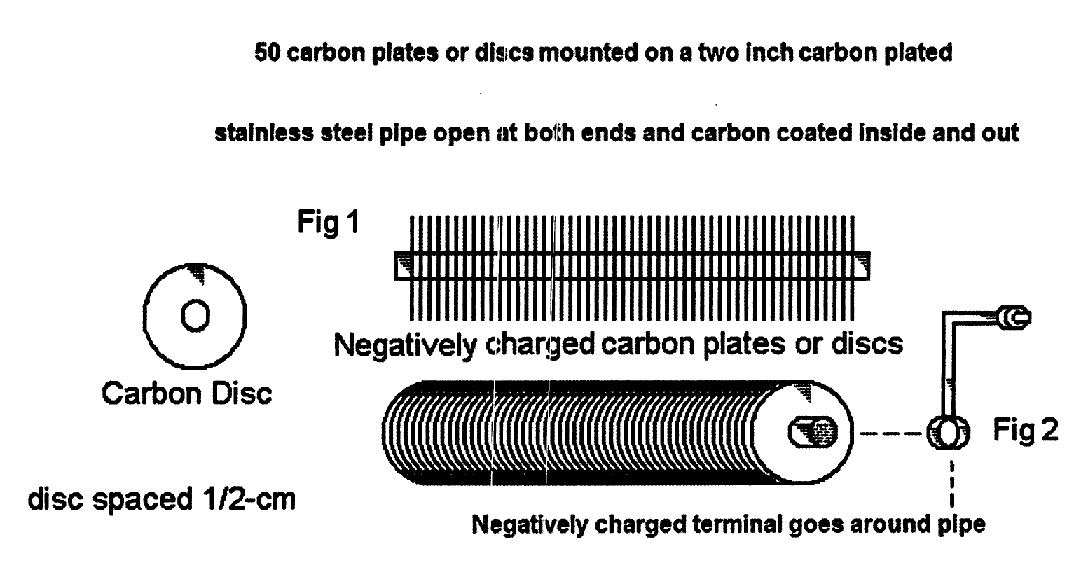

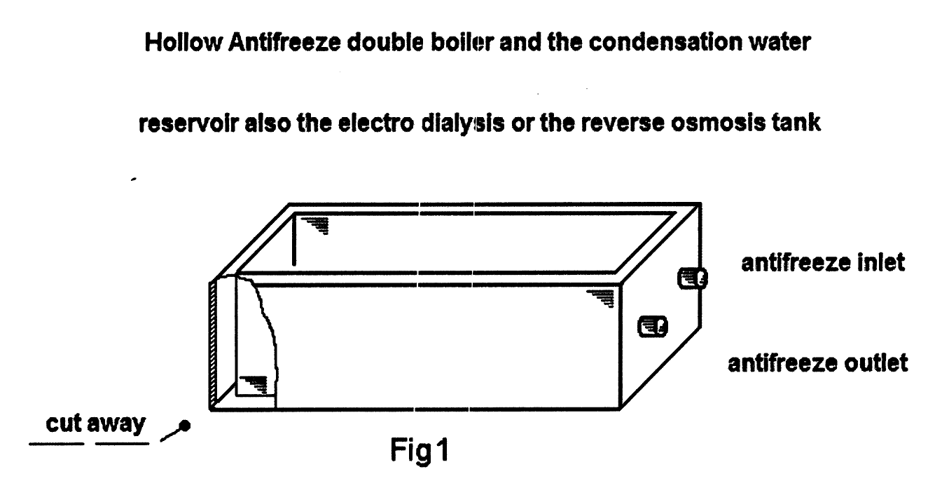

As shown on page 17 FIG. 1 Is a front-end side view of the back-up DC powered stainless steel 32750 heating element with a hot air blower fan which connects to the inlet of the exhaust pipe going to the refrigerant chamber of the fuel cell to be used when the vehicle has been turned off as a back-up system view thereof; I claim as shown on page 18 FIG. 1 is a front end side view of the triple layer refrigerant tubing view thereof; As shown on page 18 FIG. 2 is a side view of the triple layer refrigerant tubing used to create all the condensation water. The 2″ stainless steel S32750 grade exhaust pipe or tubing with holes that are placed on each side of the triple layer refrigerant tubing these holes remove the condensation water or frost from the refrigerant tubing view thereof;

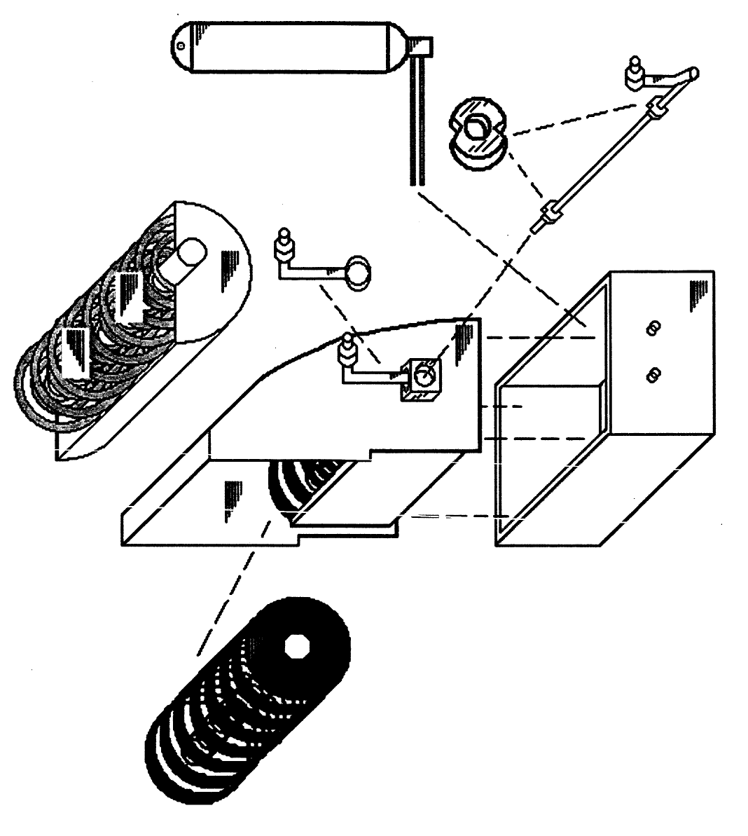

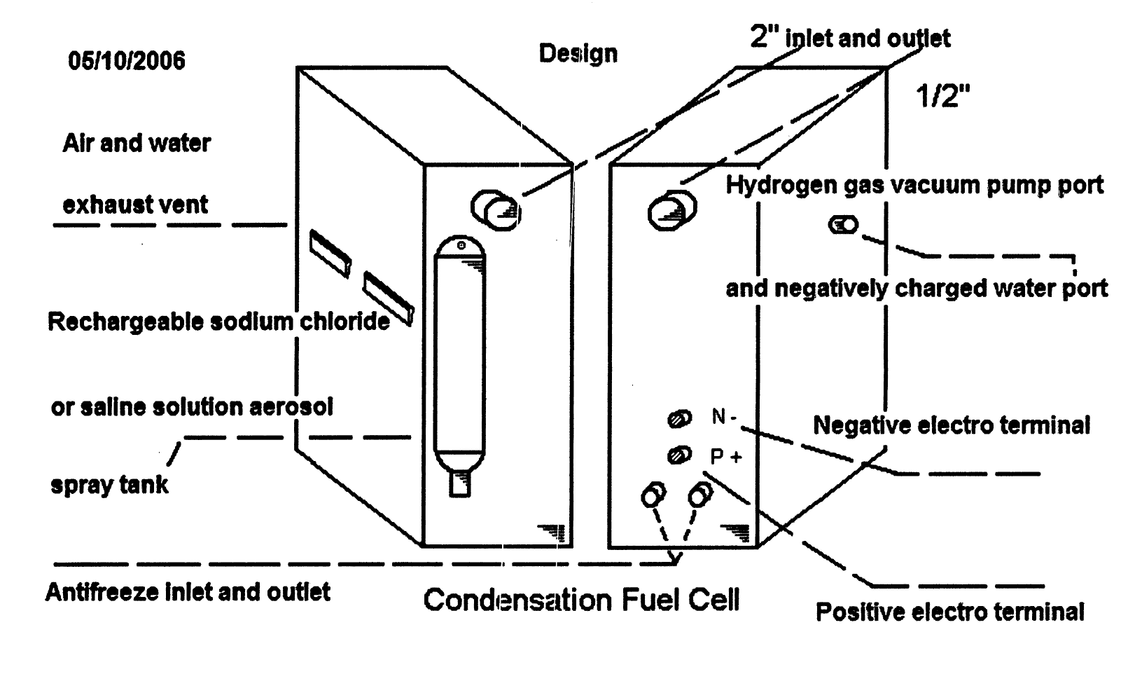

As shown on page 19 FIG. 1 shows a front side end view of the stainless steel S32750 grade refrigerant tubing chamber this chamber incases the refrigerant tubing view thereof; As shown on page 19 in FIG. 2 shows the exhaust pipe inlet from the vehicle's exhaust view thereof; As shown on page 19 FIG. 3 is the outlet for the vehicle's exhaust view thereof; As shown on page 19 FIG. 4 is a view of the bottom opening for the condensation water outlet view thereof; As shown on page 19 FIG. 5 is the recharging refrigerant storage supply tank view thereof; As shown page 19 FIG. 6 is the circulating refrigerant motor view thereof; As shown on page 20 FIG. 1 shows a end view of the stainless steel S32750 carbon plated hydrogen gas containment chamber which is welded into place inside of the outer casing view thereof; As show on page 20 FIG. 2 shows a end view of a little glass box with two holes one at the top and one through the center these are for the inlet and outlet of the air and condensation water and the positive electro-rod to slide inside of the hollow stainless steel pipe to be used as a port and spacer this allows water in and oxygen air gases out in the center is placed the positive terminal connecting port which sides into place through the center glass hole inside of the carbon coated negatively charged tubing view thereof; As shown on page 21 FIG. 1 this shows a side view of the rechargeable sodium chloride (NaCl) concentrated or saline solution aerosol spray tank or canister view thereof; As shown on page 21 FIG. 2 shows a side view of the aerosol spray nozzle view thereof; As shown on page 21 FIG. 3 shows a side end view of the PH sodium Indicator this allows the automatic sodium chloride sprayer to come on at the right PH levels view thereof; As shown on page 21 FIG. 4 shows a side end view of the aerosol recharging filling port view thereof; As shown on page 22 FIG. 1 A carbon plated positive electro rod terminal which moves all the positive current energy through the condensation water in the electro-dialysis or the reverse osmosis process this is to create all the oxygen gases which are expelled into the refrigerant chamber as they pass by the glass spacer. I claim as shown on page 22 FIG. 2 the glass spacers which allows all the oxygen gases to escape into the refrigerant chamber and lets the condensation water into the carbon plated hollow tubing for the electro-dialysis or the reverse osmosis process which allows the gases to form from the inside out, these glass spacers have a hole in the center to allow the carbon plated positive electro rod terminal to go through the center as not to touch the sides of the tubing view thereof; I claim as shown on page 23 FIG. 1 As shown is a side view of the 50 carbon plates or discs mounted in place on the carbon plated negatively charged carbon plated tubing these are to create all the hydrogen gases that get trapped under the containment chamber. I claim as shown on page 23 FIG. 2 A side end view of the negatively charging terminal which sides on the open end of the carbon plated negatively charged tubing which holds all 50 of the carbon plates to create the hydrogen gases from the negatively charged current that is needed for the electro-dialysis or the reverses osmosis process view thereof; I claim as shown on page 24 FIG. 1 A top side view of the hollow antifreeze double boiler which is the condensation water reservoir for the electro-dialysis or the reverse osmosis process this is all carbon coated and inlet and a outlet for the vehicles antifreeze system to enter and exit this is to keep the sodium chloride condensation water from freezing up in the dead of winter view thereof;

I claim:

1. The ornamental design for a self replenishing condensation fuel cell as shown.
